(19) United States
(12) Patent Application Publication
(10) Pub. No.: US 2026/0276900 A1
(43) Pub. Date: Sep. 17, 2026

(54) PHOTOELECTRIC COMPOSITE CONNECTOR INTEGRATED WITH MULTIPLE PHOTOELECTRIC CHANNELS

(71) Applicant: ACCELINK TECHNOLOGIES CO., LTD., Wuhan, Hubei (CN)

(72) Inventors: Mengming XIAO, Wuhan, Hubei (CN); Qing HE, Wuhan, Hubei (CN); Ling GUO, Wuhan, Hubei (CN); Xiaobo ZHAO, Wuhan, Hubei (CN); Huaqiang XIN, Wuhan, Hubei (CN); Chuan ZHANG, Wuhan, Hubei (CN)

(73) Assignee: ACCELINK TECHNOLOGIES CO., LTD., Wuhan, Hubei (CN)

(21) Appl. No.: 19/168,932

(22) PCT Filed: Jun. 17, 2024
(86) PCT No.: PCT/CN2024/099670

§ 371 Date: Sep. 25, 2025

(30) Foreign Application Priority Data
Jul. 17, 2023 (CN) 202310879747.8

(51) Int. Cl. G02B 6/38; H01R 24/62

(52) U.S. Cl. CPC G02B 6/3817; H01R 24/62

(57) ABSTRACT

Disclosed in the present disclosure is a photoelectric composite connector integrated with multiple photoelectric channels. By proving a center joint and a peripheral joint provided at a front end of the photoelectric composite joint, wherein a plurality of plug-side optical interfaces are provided on an end face of the center joint, and a plurality of plug-side electric interfaces are provided on a side face of the peripheral joint; and correspondingly, a plurality of socket-side optical interfaces and a plurality of socket-side electric interfaces are provided in a socket slot of the photoelectric composite socket, after the front end of the photoelectric composite joint is inserted into the socket slot of the photoelectric composite socket, the plug-side optical interfaces are correspondingly connected with the socket-side optical interfaces, and the plug-side electric interfaces are correspondingly connected with the socket-side electric interfaces, thereby realizing photoelectric composite transmission of multiple photoelectric channels.

### CROSS-REFERENCE TO BE RELATED APPLICATIONS

This disclosure claims priority to the following patent application:
(1) Chinese patent application with the application number of 202310879747.8 filed to China National Intellectual Property Administration on Jul. 17, 2023, titled “PHOTOELECTRIC COMPOSITE CONNECTOR INTEGRATED WITH MULTIPLE PHOTOELECTRIC CHANNELS”.

### TECHNICAL FIELD

The present disclosure relates to the technical field of optical communication, and in particular, to a photoelectric composite connector integrated with multiple photoelectric channels.

### BACKGROUND

In the conventional technologies, the photoelectric composite cable is generally simply applied as an optical fiber cable and an energy transmission line which are deployed together, and in the use, the optical cables and the electric cables at both ends are respectively connected with the optical fiber connector and the electric socket, then the light and the electricity are directly inserted into the corresponding sockets to implement networking, most of which use POE (Power Over Ethernet) photoelectric composite connectors. In most of the POE photoelectric composite connector, the photoelectric composite is designed through an LC (Line Connector) optical interface or an SC (Subscriber Connector) optical interface. Either of the LC optical interface or the SC optical interface is a single-core optical fiber which is a single-core ceramic circular hole, and there are less optical channels under this design. But the existing multi-optical-core connectors are MT connectors and MPO connectors, and none of the above-mentioned connectors is integrated with electric channels, which renders an application scene applicability of the multi-channel optical fiber parallel transceiving signal be preferential. Therefore, when multi-optical fibers are required to take into account the scene of the transmission of the electric signal and the electrical energy at the same time, the above-mentioned existing products cannot realize the transmission.

Given this, overcoming the shortcomings of the prior art is an urgent issue in this technical field.

### SUMMARY

The technical problem to be solved in the present disclosure is how to integrate multiple optical channels and multiple electric channels in the same connector.

The present disclosure uses the following technical solutions.

In a first aspect, there is provided a photoelectric composite connector integrated with multiple photoelectric channels comprising a photoelectric composite joint 1 and a photoelectric composite socket 2, wherein:
a front end of the photoelectric composite joint 1 comprises a center joint 11 and a peripheral joint 12, and the peripheral joint 12 is arranged around a periphery of the center joint 11;
at least two plug-side optical interfaces 13 are provided on an end face of the center joint 11, and at least two plug-side electric interfaces 14 are provided on a side face of the peripheral joint 12;
a front end of the photoelectric composite socket 2 comprises a socket slot 21, wherein at least two socket-side optical interfaces 22 are provided on an inner end face of the socket slot 21, and at least two socket-side electric interfaces 23 are provided on an inner side wall of the socket slot 21;
when the front end of the photoelectric composite joint 1 is inserted into the socket slot 21 of the photoelectric composite socket 2, the plug-side optical interfaces 13 are connected with the socket-side optical interfaces 22 for transmitting optical signals, and the plug-side electric interfaces 14 are connected with the socket-side electric interfaces 23 for transmitting electric signals.

Preferably, a rear end of the photoelectric composite joint 1 is connected with a photoelectric composite cable 15, and the photoelectric composite cable 15 comprises an optical transmission cable and an electric transmission cable, wherein:
the optical transmission cable is connected with the plug-side optical interface 13 of the center joint 11; and
the electric transmission cable is connected with the plug-side electric interface 14 of the peripheral joint 12.

Preferably, each plug-side electric interface 14 comprises an interface slot 141 and a metal elastic sheet 142, wherein:
the interface slot 141 is provided on a surface of the side face of the peripheral joint 12, and the metal elastic sheet 142 is connected with the electric transmission cable and extends out of the surface of the peripheral joint 12 through the interface slot 141;
when the front end of the photoelectric composite joint 1 is inserted into the socket slot 21 of the photoelectric composite socket 2, the metal elastic sheet 142 is configured to be pressed by the photoelectric composite joint 1 and is connected with the socket-side electric interface 23.

Preferably, the metal elastic sheet 142 comprises a long side 1421, a short side 1422 and a bottom edge 1423, wherein:
the bottom edge 1423 is located in an interior of the interface slot 141 and is connected with the electric transmission cable;
one end of the long side 1421 is elastically connected with the bottom edge 1423, the other end of the long side 1421 extends out of one end of an outer side of the interface slot 141 and is elastically connected with one end of the short side 1422 in a preset angle, while the other end of the short side 1422 is immerged into the interface slot 141;
when the front end of the photoelectric composite joint 1 is inserted into the socket slot 21 of the photoelectric composite socket 2, the photoelectric composite joint 1 presses the long side 1421, pressing both the long side 1421 and the short side 1422 into the interior of the interface slot 141, and the long side 1421 is configured to be connected with the socket-side electric interface 23.

Preferably, a positioning empty slot 16 is disposed between the center joint 11 and the peripheral joint 12, and a positioning convex plate 24 is provided on a periphery of the socket-side optical interface 22 in the socket slot 21; and
when the front end of the photoelectric composite joint 1 is inserted into the socket slot 21 of the photoelectric composite socket 2, the positioning convex plate 24 is configured to be inserted into the positioning empty slot 16.

Preferably, chamfer buckles 25 are provided on both sides of the photoelectric composite socket 2, and buckle slots 17 are provided on both sides of the peripheral joint 12;
when the front end of the photoelectric composite joint 1 is inserted into the socket slot 21 of the photoelectric composite socket 2, the chamfer buckle 25 is located in the buckle slot 17, and an inner side of the chamfer buckle 25 abuts against an inner side wall of the buckle slot 17, so as to realize the fixation of the photoelectric composite joint 1 and the photoelectric composite socket 2.

Preferably, when the front end of the photoelectric composite joint 1 is inserted into the socket slot 21 of the photoelectric composite socket 2, the socket-side electric interface 23 is connected with the plug-side electric interface 14 as an electric channel, and the electric channel comprises an electric energy channel A and an electric signal channel B;
wherein a first preset quantity of the socket-side electric interface 23 is connected with the first preset quantity of the plug-side electric interface 14 as the electric signal channel B, and a second preset quantity of the socket-side electric interface 23 is connected with the second preset quantity of the plug-side electric interface 14 as the electric energy channel A.

Preferably, every two or more electric signal channels B are adjacently arranged as one group, and at least one electric energy channel A is arranged between each group of electric signal channel B to separate different groups of electric signal channels B.

Preferably, a convex plate 18 is provided on an inner side end, opposite to the plug-side electric interface 14, of the peripheral joint 12, and a groove 26 is provided in an inner side end, opposite to the socket-side electric interface 23, of the socket slot 21; and when the front end of the photoelectric composite joint 1 is inserted into the socket slot 21 of the photoelectric composite socket 2, the convex plate 18 is inserted into the groove 26.

Preferably, the optical signal comprises one or more of a digital signal, an analog signal and a high-order modulation signal, and the electric signal comprises: one or more of a digital signal, an analog signal, a high-order modulation signal, a time division multiplexing signal, a wavelength division multiplexing signal, and a power carrier signal.

The present disclosure provides a photoelectric composite connector integrated with multiple photoelectric channels. By proving a center joint and a peripheral joint provided at a front end of the photoelectric composite joint, wherein a plurality of plug-side optical interfaces are provided on an end face of the center joint, and a plurality of plug-side electric interfaces are provided on a side face of the peripheral joint; and correspondingly, a plurality of socket-side optical interfaces and a plurality of socket-side electric interfaces are provided in a socket slot of the photoelectric composite socket, after the front end of the photoelectric composite joint is inserted into the socket slot of the photoelectric composite socket, the plug-side optical interfaces are correspondingly connected with the socket-side optical interfaces, and the plug-side electric interfaces are correspondingly connected with the socket-side electric interfaces, thereby realizing photoelectric composite transmission of multiple photoelectric channels.

### BRIEF DESCRIPTION OF THE DRAWINGS

In order to more clearly illustrate the technical solutions of the embodiments of the present disclosure, the drawings required in the embodiments of the present disclosure are briefly described below. Obviously, the drawings in the following description are some embodiments of the present disclosure, and for those skilled in the art, other drawings may be obtained according to these drawings without any inventive labor.

FIG. 1 is a schematic structural diagram of a photoelectric composite connector integrated with multiple photoelectric channels according to an embodiment of the present disclosure.

FIG. 2 is a schematic diagram of a front end of a photoelectric composite joint of a photoelectric composite connector integrated with multiple photoelectric channels according to an embodiment of the present disclosure.

FIG. 3 is another schematic diagram of a front end of a photoelectric composite joint of a photoelectric composite connector integrated with multiple photoelectric channels according to an embodiment of the present disclosure.

FIG. 4 is a schematic diagram of a front end of a photoelectric composite socket of a photoelectric composite connector integrated with multiple photoelectric channels according to an embodiment of the present disclosure.

FIG. 5 is a schematic structural diagram of a photoelectric composite joint of a photoelectric composite connector integrated with multiple photoelectric channels according to an embodiment of the present disclosure.

FIG. 6 is another schematic diagram of a front end of a photoelectric composite joint of a photoelectric composite connector integrated with multiple photoelectric channels according to an embodiment of the present disclosure.

FIG. 7 is a cross-sectional view of a photoelectric composite joint of a photoelectric composite connector integrated with multiple photoelectric channels according to an embodiment of the present disclosure.

FIG. 8 is a cross-sectional view of a photoelectric composite joint of a photoelectric composite connector integrated with multiple photoelectric channels according to an embodiment of the present disclosure during an insertion process.

FIG. 9 is a cross-sectional view of a photoelectric composite joint of a photoelectric composite connector integrated with multiple photoelectric channels according to an embodiment of the present disclosure after being inserted.

FIG. 10 is yet another schematic diagram of a front end of a photoelectric composite joint of a photoelectric composite connector integrated with multiple photoelectric channels according to an embodiment of the present disclosure.

FIG. 11 is another schematic diagram of a front end of a photoelectric composite joint of a photoelectric composite connector integrated with multiple photoelectric channels according to an embodiment of the present disclosure.

FIG. 12 is yet another schematic diagram of a front end of a photoelectric composite joint of a photoelectric composite connector integrated with multiple photoelectric channels according to an embodiment of the present disclosure.

FIG. 13 is yet another schematic diagram of a front end of a photoelectric composite socket of a photoelectric composite connector integrated with multiple photoelectric channels according to an embodiment of the present disclosure.

FIG. 14 is an abbreviated structural diagram of an end face of a photoelectric composite joint or a photoelectric composite socket of a photoelectric composite connector integrated with multiple photoelectric channels according to an embodiment of the present disclosure.

FIG. 15 is another schematic diagram of a front end of a photoelectric composite joint of a photoelectric composite connector integrated with multiple photoelectric channels according to an embodiment of the present disclosure.

FIG. 16 is another schematic diagram of a front end of a photoelectric composite joint of a photoelectric composite connector integrated with multiple photoelectric channels according to an embodiment of the present disclosure.

FIG. 17 is a schematic diagram of an interface definition of a photoelectric composite connector integrated with multiple photoelectric channels according to an embodiment of the present disclosure.

### LIST OF REFERENCE SIGNS

Photoelectric composite joint 1
Center joint 11
Peripheral joint 12
Plug-side optical interface 13
Plug-side electric interface 14
Interface slot 141
Metal elastic sheet 142
Long side 1421
Short side 1422
Bottom edge 1423
Photoelectric composite cable 15
Optical transmission cable
Electric transmission cable
Positioning empty slot 16
Buckle slot 17
Convex plate 18
Photoelectric composite socket 2
Socket slot 21
Socket-side optical interface 22
Socket-side electric interface 23
Positioning convex plate 24
Chamfer buckle 25
Electric energy channel A
Electric signal channel B

### DETAILED DESCRIPTION

In order to make the objectives, technical solutions and advantages of the present disclosure clearer, the present disclosure will be further described in detail below with reference to the drawings and embodiments. It should be understood that the specific embodiments described herein are only used to explain the present disclosure but not intended to limit the present disclosure.

In the description of the present disclosure, the orientations or position relationships indicated by the terms “inner”, “outer”, “longitudinal”, “lateral”, “upper”, “lower”, “top”, “bottom” and the like are based on the orientations or positional relationships shown in the drawings, and are only for the purpose of describing the present disclosure rather than requiring the present disclosure must be constructed and operated in a specific orientation, but should not be understood as a limitation to the present disclosure.

The terms “first” and “second” in the present invention are only used for describing purposes and cannot be understood as indicating or implying relative importance or implicitly indicating the number of indicated technical features. Thus, the features defined by “first”, “second” and so on may explicitly or implicitly include one or more of these features. In the description of the present disclosure, unless otherwise specified, the meaning of “a plurality of” refers to two or more.

In the present disclosure, unless otherwise specified and limited, the term “connection” should be broadly understood, for example, “connection” can be a fixed connection, a detachable connection, or an integrated one; and it can be directly connected or indirectly connected through an intermediate medium. In addition, the term “coupling” can be a way to realize an electrical connection for signal transmission.

In addition, the technical features involved in various embodiments of the present disclosure described below can be combined with each other as long as they do not conflict with each other.

### Embodiment 1

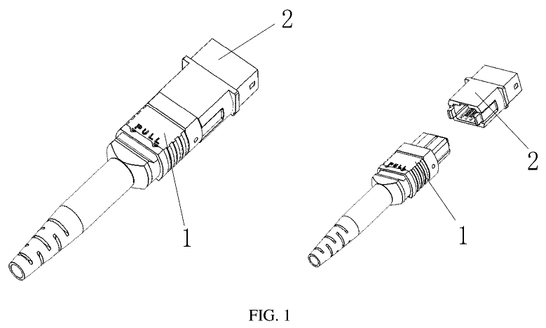

Embodiment 1 of the present disclosure provides a photoelectric composite connector integrated with multiple photoelectric channels, as shown in FIG. 1, comprising a photoelectric composite joint 1 and a photoelectric composite socket 2, wherein:

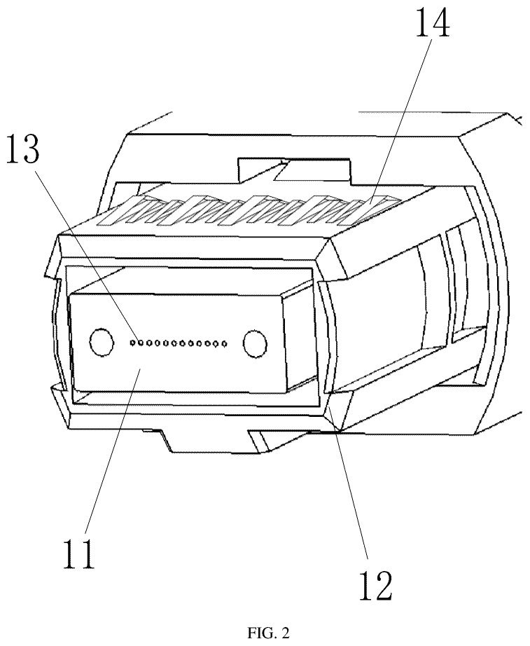

As shown in FIG. 2, a front end of the photoelectric composite joint 1 comprises a center joint 11 and a peripheral joint 12, and the peripheral joint 12 is arranged around the periphery of the center joint 11.

As shown in FIG. 2, in the present embodiment, the center joint 11 and the peripheral joint 12 are located at the front end of the photoelectric composite joint 1, while a rear end of the photoelectric composite joint 1 is a housing, which is usually a plastic product, and the center joint 11 and the peripheral joint 12 are both provided on an end face of the housing, which are configured to be inserted into the photoelectric composite socket 2. In the present embodiment, the center joint 11 is in a cuboid shape, and is disposed in the true center of the end face of the housing, and the peripheral joint 12 is in a hollow cylindrical shape, and is disposed around the center joint 11. As shown in FIG. 2, the peripheral joint 12 is a hollow cuboid, which is matched with the center joint 11 at the center in shape, and an interval space exists between the center joint 11 and the peripheral joint 12 to distinguish the two joints.

As shown in FIG. 2, at least two plug-side optical interfaces 13 are provided on an end face of the center joint 11, and at least two plug-side electric interfaces 14 are provided on a side face of the peripheral joint 12.

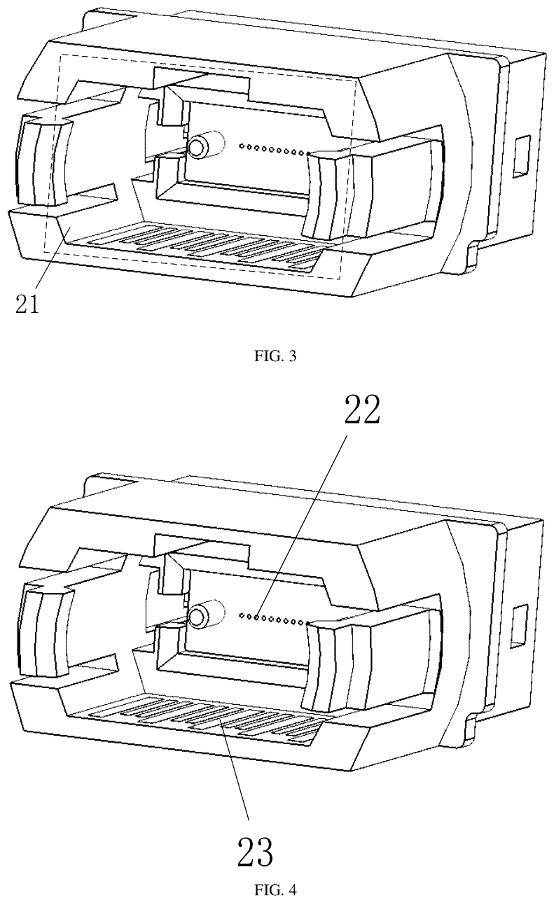

As shown in FIGS. 3 and 4, a front end of the photoelectric composite socket 2 comprises a socket slot 21, wherein at least two socket-side optical interfaces 22 are provided on an inner end face of the socket slot 21, and at least two socket-side electric interfaces 23 are provided on an inner side wall of the socket slot 21.

The end face of the center joint 11 is an outward-facing face of the center joint 11 in FIG. 2, and at least two plug-side optical interfaces 13 are provided on the end face of the center joint 11 and are configured to transmit optical signals. The side face of the peripheral joint 12 is an upper side face of the peripheral joint 12 in FIG. 2, and at least two plug-side electric interface 14 are provided on the side face of the peripheral joint 12. As shown in FIG. 3 and FIG. 4, the socket-side electric interface 23 is provided on a lower end side wall of the inner side wall of the socket slot 21 in FIG. 4.

It should be noted that, in the present embodiment, the plug-side optical interfaces 13 are in a standard multi-optical-core arrangement of an MT connector or an MPO connector, and the plug-side optical interfaces 13 are arrayed in an array on the end face of the center joint 11.

When the front end of the photoelectric composite joint 1 is inserted into the socket slot 21 of the photoelectric composite socket 2, the plug-side optical interfaces 13 are connected with the socket-side optical interfaces 22 for transmitting optical signals, and the plug-side electric interfaces 14 are connected with the socket-side electric interfaces 23 for transmitting electric signals.

In the present embodiment, that the front end of the photoelectric composite joint 1 is inserted into the socket slot 21 of the photoelectric composite socket 2 refers to that the photoelectric composite joint 1 is butted with the photoelectric composite socket 2, wherein the end face of the center joint 11 abuts against the inner end face of the socket slot 21 of the photoelectric composite socket 2, and the side face of the peripheral joint 12 abuts against the inner side wall of the socket slot 21, so as to ensure the plug-side optical interface 13 be connected with the socket-side optical interface 22, and the plug-side electric interface 14 is connected with the socket-side electric interface 23.

It should be noted that, in the present embodiment, the optical signal transmitted by an optical channel comprises one or more of a digital signal, an analog signal and a high-order modulation signal, and the electric signal transmitted by an electric channel comprises one or more of a digital signal, an analog signal, a high-order modulation signal, a time division multiplexing signal, a wavelength division multiplexing signal, and a power carrier signal.

In the prior art, in most cases, the photoelectric composite cable 15 is simply applied as an optical fiber cable and an energy transmission line which are deployed together, and in the use, the optical cable and electric cable at both ends are respectively connected with the optical fiber connector and the electric socket, then the light and the electricity are directly inserted into the corresponding sockets to implement networking, most of which use POE photoelectric composite connectors. In most of the POE photoelectric composite connector, the photoelectric composite is designed through an LC optical interface or an SC optical interface, while either of the LC optical interface or the SC optical interface is a single-core optical fiber which is a single-core ceramic circular hole. There are less optical channels under this design, while the existing multi-optical-core connectors are MT connectors and MPO connectors, and none of the above-mentioned connectors are integrated with electric channels, which renders the application scene applicability of the multi-channel optical fiber parallel transceiving signal be preferential. Therefore, when multi-optical fibers are required to take into account the scene of the transmission of the electric signal and the electrical energy at the same time, the above-mentioned existing products cannot realize the above transmission.

In the present embodiment, the center joint 11 and the peripheral joint 12 are provided at the front end of the photoelectric composite joint 1, wherein a plurality of plug-side optical interfaces 13 are provided on the end face of the center joint 11, and a plurality of plug-side electric interfaces 14 are provided on the side face of the peripheral joint 12; and correspondingly, a plurality of socket-side optical interfaces 22 and a plurality of socket-side electric interfaces 23 are provided in a socket slot 21 of a photoelectric composite socket 2, and after the front end of the photoelectric composite joint 1 is inserted into the socket slot 21 of the photoelectric composite socket 2, the plug-side optical interfaces 13 are correspondingly connected with the socket-side optical interfaces 22, and the plug-side electric interfaces 14 are correspondingly connected with the socket-side electric interfaces 23, thereby realizing photoelectric composite transmission of multiple photoelectric channels.

In the present embodiment, the photoelectric composite joint 1 needs to transmit optical signals, electric signals and electric energy, and thus it needs to be connected with the optical channel and the electric channel. In this way, the present embodiment relates to the following design.

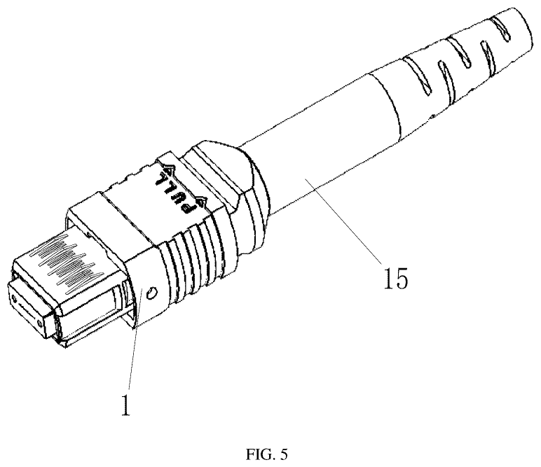

As shown in FIG. 5, the rear end of the photoelectric composite joint 1 is connected with a photoelectric composite cable 15, and the photoelectric composite cable 15 comprises an optical transmission cable and an electric transmission cable,
wherein the optical transmission cable is connected with the plug-side optical interface 13 of the center joint 11, and the electric transmission cable is connected with the plug-side electric interface 14 of the peripheral joint 12.

in the present embodiment, when the photoelectric composite cable 15 is butted with the photoelectric composite joint 1, the photoelectric composite cable 15 is divided into an optical transmission cable and an electric transmission cable, wherein the optical transmission cable is directly connected with the plug-side optical interface 13 in the center joint 11, and the electric transmission cable enters the interior of the peripheral joint 12 and is connected with the plug-side electric interface 14.

In the present embodiment, considering that it is necessary to ensure a stable contact connection between the plug-side electric interface 14 and the socket-side electric interface 23 when transmitting electric signal or electric energy, however, since the plug-side electric interface 14 is provided on the side face of the peripheral joint 12, while the socket-side electric interface 23 is provided on the inner side surface of the socket side, when the photoelectric composite joint 1 is inserted into the photoelectric composite socket 2, the butt connection between the plug-side electric interface 14 and the socket-side electric interface 23 is not in an insertion stress direction, and thus if the abutting contact between the plug-side electric interface 14 and the socket-side electric interface 23 is only the abutting contact between planes, the stable contact connection between them cannot be ensured. Therefore, the present embodiment further relates to the following design.

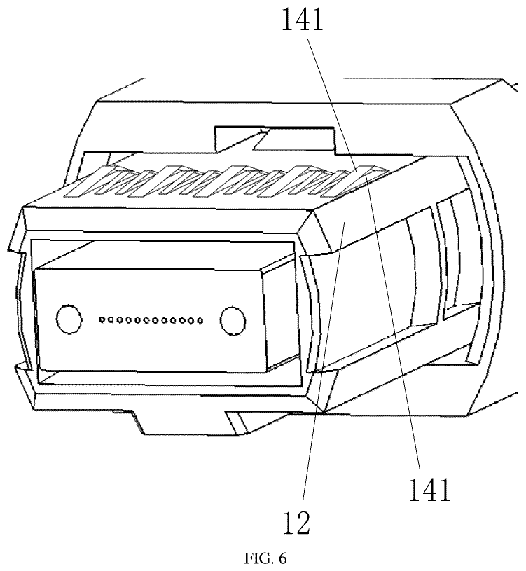

As shown in FIG. 6, each plug-side electric interface 14 comprises an interface slot 141 and a metal elastic sheet 142,
wherein the interface slot 141 is provided on a surface of the side face of the peripheral joint 12, and the metal elastic sheet 142 is connected with the electric transmission cable and extends out of the surface of the peripheral joint 12 through the interface slot 141; and when the front end of the photoelectric composite joint 1 is inserted into the socket slot 21 of the photoelectric composite socket 2, the metal elastic sheet 142 is configured to be pressed by the photoelectric composite joint 1 and is connected with the socket-side electric interface 23.

In the present embodiment, the interface slots 141 are all strip-shaped slots, and lead to the interior of the peripheral joint 12, and the electric transmission cable enters the interior of the peripheral joint 12 from the housing of the rear end, enabling one side of the metal elastic sheet 142 to be connected with the electric transmission cable within the interface slot 141, and the other side of the metal elastic sheet 142 to extend out of the interface slot 141. When the front end of the photoelectric composite joint 1 is inserted into the socket slot 21 of the photoelectric composite socket 2, and when the part of the metal elastic sheet 142 extending out of the interface slot 141 is subjected to the pressure from the socket-side electric channel, it will be pressed into the interior of the interface slot 141, while the elastic restoring force of the metal elastic sheet 142 enables the metal elastic sheet 142 to abut against the socket-side electric channel, which ensures the metal elastic sheet 142 to be tightly connected with the socket-side electric channel, and when the front end of the photoelectric composite joint 1 is pulled out from the socket slot 21, the pressure which is subjected to by the part of the metal elastic sheet 142 extending out of the interface slot 141 is removed, and the metal elastic sheet 142 rebounds and protrudes again from the interface slot 141 due to the elastic restoring force.

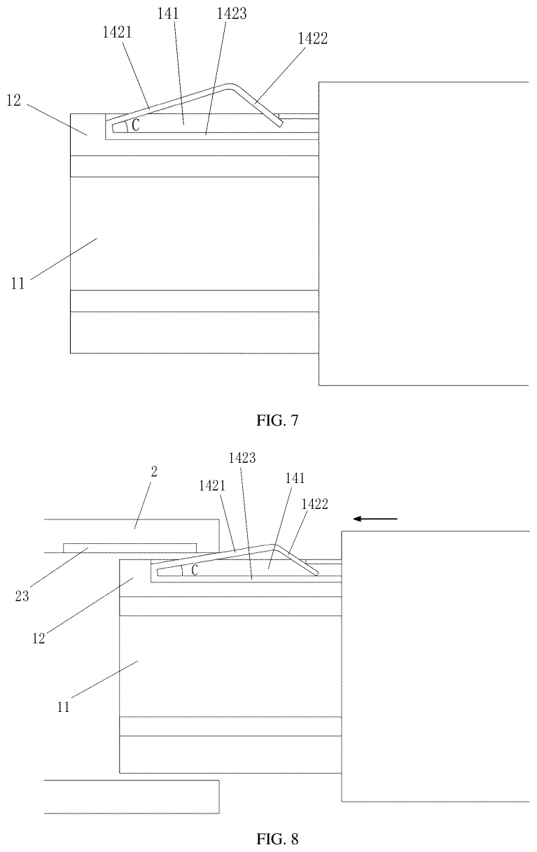

In the present embodiment, as shown in FIGS. 7-9, the metal elastic sheet 142 comprises a long side 1421, a short side 1422 and a bottom edge 1423, wherein:
the bottom edge 1423 is located in the interface slot 141 and is connected with the electric transmission cable, with one end of the long side 1421 elastically connected with the bottom edge 1423, and the other end of the long side 1421 extends out of one end of an outer side of the interface slot 141, and is elastically connected with one end of the short side 1422 in a preset angle, while the other end of the short side 1422 is immerged into the interface slot 141.

When the front end of the photoelectric composite joint 1 is inserted into the socket slot 21 of the photoelectric composite socket 2, the photoelectric composite joint 1 presses the long side 1421, pressing both the long side 1421 and the short side 1422 into the interior of the interface slot 141, and the long side 1421 is configured to connect with the socket-side electric interface 23.

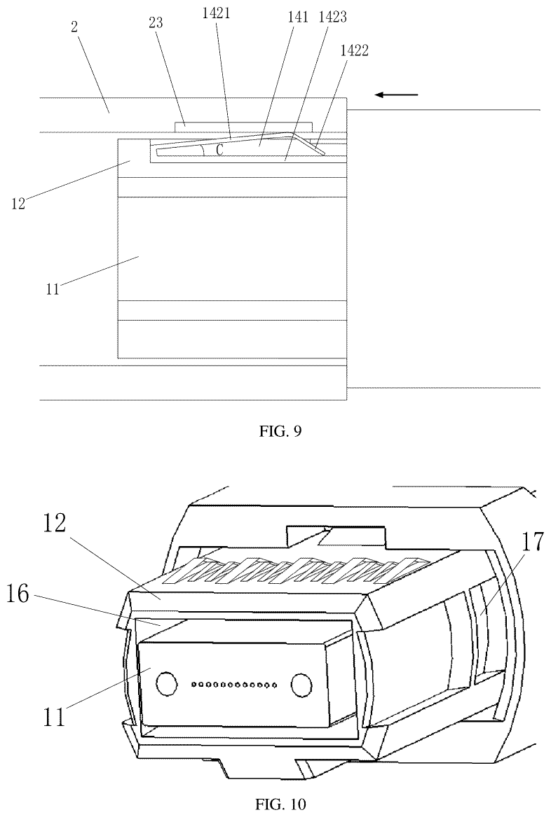

In the present embodiment, as shown in FIG. 7, the long side 1421, the short side 1422 and the bottom edge 1423 are all strip-shaped metals, and the long side 1421, the short side 1422 and the bottom edge 1423 are integrally formed. The bottom edge 1423 is located in the interface slot 141 and is parallel to the surface of the peripheral joint 12, and the long side 1421 and the bottom side 1423 are connected at an acute angle, that is, an angle C shown in the figure. The preset angle is voluntarily set by the skilled person in the art, and in present embodiment, the preset angle is an obtuse angle. One end of the outer side of the interface slot 141 is one end, facing the insertion direction, of the interface slot 141, while one end of the inner side of the interface slot 141 is one end, opposite to the insertion direction, of the interface slot 141, and the position where the long side 1421 is connected with the short side 1422 is located at an upper end of the interface slot 141 close to the middle. In the present embodiment, one end of the long side 1421 is elastically connected with the bottom edge 1423, and one end of the short side 1422 is not connected with one end of the inner side of the interface slot 141. As shown in FIG. 8 and FIG. 9, when the front end of the photoelectric composite joint 1 is inserted into the socket slot 21 of the photoelectric composite socket 2, that is, the arrows in FIGS. 8 and 9, represents the direction of the insertion of the photoelectric composite joint 1, and the front end of the photoelectric composite joint 1 is firstly in contact with the long side 1421, and presses the metal elastic sheet 142 along the long side 1421. It can be seen from FIGS. 8 to 9 that, at this moment, the angle C is gradually reduced until the front end of the photoelectric composite joint 1 reaches the vertex of the metal elastic sheet 142, i.e. the connection point between the long side 1421 and the short side 1422, the metal elastic sheet 142 is completely pressed into the interface slot 141. Both the long side 1421 and the short side 1422 may be extended downwards in the interface slot 141 and may be connected with the electric transmission cable.

The center joint 11 and the peripheral joint 12 are respectively configured to transmit optical signals and electric signals or electric energy, and thus the two joints need to be distinguished from each other. Moreover, in order to ensure that the center joint 11 abuts against the inner end face of the socket slot 21 accurately, so as to ensure that the plug-side optical interface 13 and the socket-side optical interface 22 can be precisely butted with each other, the present embodiment further relates to the following design:

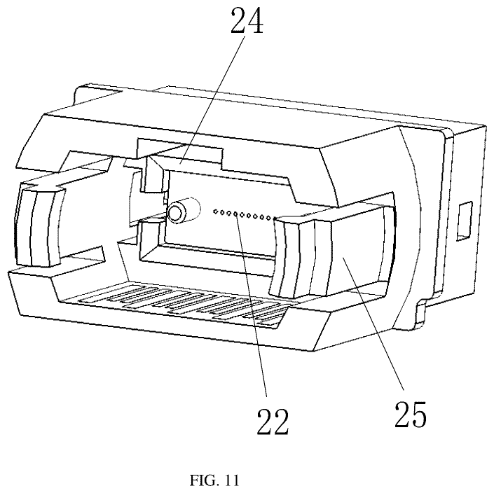

As shown in FIG. 10 11, a positioning empty slot 16 is provided between the center joint 11 and the peripheral joint 12, and a positioning convex plate 24 is provided on the periphery of a socket-side optical interface 22 in the socket slot 21, and is configured to be inserted into the positioning empty slot 16 when the front end of the photoelectric composite joint 1 is inserted into the socket slot 21 of the photoelectric composite socket 2.

In the present embodiment, the peripheral joint 12 is in the shape of a hollow column of the square body, and the center joint 11 is in the shape of a column, and thus the contour of the positioning empty groove 16 is in the shape of a hollow column, and the contour of the positioning convex plate 24 is consistent with that of the positioning empty slot 16. When the front end of the photoelectric composite joint 1 is inserted into the socket slot 21 of the photoelectric composite socket 2, the center joint 11 is inserted into the center of the positioning convex plate 24 to position the center joint 11.

After the front end of the photoelectric composite joint 1 is inserted into the socket slot 21 of the photoelectric composite socket 2, due to the fact that the long-time insertion state needs to be kept, the photoelectric composite joint 1 needs to be fixed to the photoelectric composite socket 2 after insertion, and thus the present embodiment relates to the following design:

As shown in FIGS. 10 and 11, chamfer buckles 25 are provided on both sides of the photoelectric composite socket 2, and buckle slots 17 are provided on both sides of the peripheral joint 12; and when the front end of the photoelectric composite joint 1 is inserted into the socket slot 21 of the photoelectric composite socket 2, the chamfer buckle 25 is located in the buckle slot 17, and an inner side of the chamfer buckle 25 abuts against an inner side wall of the buckle slot 17, so as to realize the fixation of the photoelectric composite joint 1 and the photoelectric composite socket 2.

Here, a chamfer at a front end of the chamfer buckle 25 faces the inner side of the socket slot 21, and an inclined surface of the chamfer faces the insertion direction of the photoelectric composite joint 1. When the photoelectric composite joint 1 is inserted into the socket slot 21, the photoelectric composite joint 1 stretches the chamfer buckle 25 towards the both sides along the inclined plane of the chamfer until the chamfer reaches a position where the buckle slot 17 is located, and the chamfer is rebounded into the buckle slot 17 by means of a rebound force of the chamfer buckle 25 itself. An inner side of the chamfer buckle 25 is a barb portion of the chamfer is located, and after the chamfer rebounds into the buckle slot 17, the barb portion of the chamfer is stuck on an inner wall of the buckle slot 17, preventing the photoelectric composite joint 1 from disengaging from the photoelectric composite socket 2.

In the prior art, the general photoelectric composite connector can only transmit electric energy but cannot transmit electric signals. In order to further improve the integration degree of the photoelectric composite connector provided by the embodiment, the embodiment further relates to the following design:

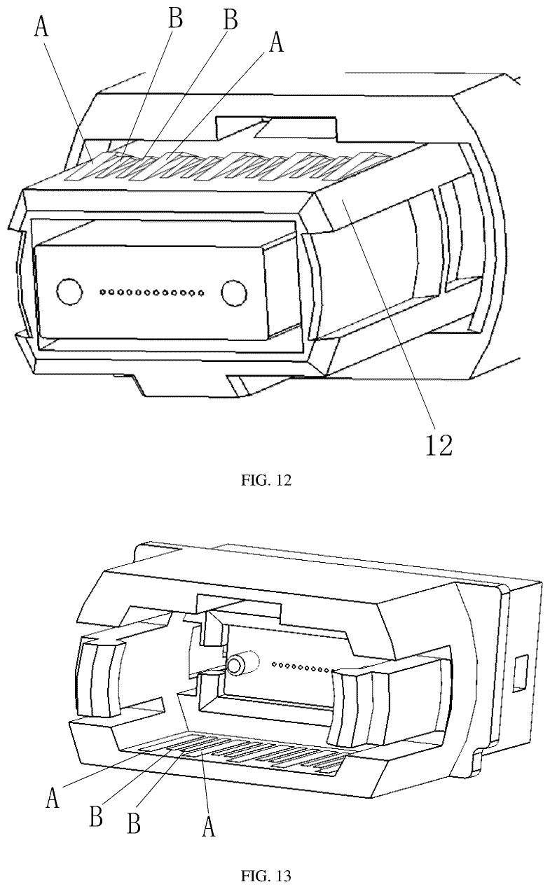

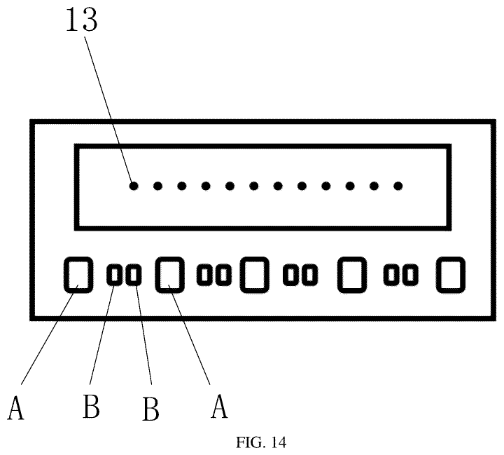

As shown in FIGS. 12 to 14, with FIG. 14 being an abbreviated diagram of an end face of the photoelectric composite joint 1 or the photoelectric composite socket 2, when the front end of the photoelectric composite joint 1 is inserted into the socket slot 21 of the photoelectric composite socket 2, the socket-side electric interfaces 23 is connected with the plug-side electric interface 14 as an electric channel, and the electric channel comprises electric energy channels A and electric signal channels B, wherein the first preset quantity of the socket-side electric interfaces 23 are respectively connected with the first preset quantity of the plug-side electric interfaces 14 as the electric signal channels B, and the second preset quantity of the socket-side electric interfaces 23 are respectively connected with the second preset quantity of the plug-side electric interfaces 14 as the electric energy channels A.

In the present embodiment, both the first preset quantity and the second preset quantity are set by those skilled in the art by themselves; and the electric energy channel A is configured to transmit electric energy, and the electric signal channel B is configured to transmit an electric signal. As shown in FIGS. 12 to 14, the present embodiment further provides a preferable arrangement design of the socket-side electric channels, in which every two electric signal channels B are adjacently arranged as one group, and each group of electric signal channels B is further separated through a single electric energy channel A, wherein that the two electric signal channels B are adjacently arranged as one group is due the fact that: at the present stage, the electric signals needs to be phase-flipped by 180 degrees during transmission, so as to ensure the transmission distance of the electric signals, and thus each group needs at least two adjacent electric signal channels B for differential setting; due to the fact that high-frequency electric signals are often transmitted in the electric signal transmission channels, the interference from low-frequency signals may occur between adjacent channels due to high-frequency electrical signals, whereby in the present embodiment, the electric energy channel A is arranged between different groups of the electric signal channels B for being separated, thereby avoiding mutual interference between different groups of electric signal channels B. As shown in FIG. 14, a large square represents an electric energy channel A, while a small square represents an electric signal channel B, and it can be seen that every two electric signal channels B are adjacently arranged as one group, and an electric energy channel A is arranged between each group of electric signal channels B for being separated.

Since the plug-side electric channel is provided on one side of the peripheral joint 12, while the other side of the peripheral joint 12 is not provided with the plug-side electric channel, in actual use, a user needs to confirm in advance that the plug-side electric channel is located on which surface of the photoelectric composite joint 1, and the socket-side electric channel is located on which surface of the photoelectric composite socket 2, so as to connect the plug-side electric channel and the socket-side electric channel correspondingly. If no confirmation is made in advance, it may render the photoelectric composite plug be inserted reversely, resulting in the plug-side electric channel and the socket-side electric channel not being connected correspondingly, while it is often tedious to do in advance, resulting in a poor actual use experience, and if the confirmation is forgotten by a user and direct insertion is performed, it will lead to an insertion error, which may cause more serious consequences. If it is designed to be inserted directly without prior confirmation, the photoelectric composite joint 1 will not be able to be directly inserted when it is inserted in reverse, and the above-mentioned design is often more direct and convenient, and can also prevent insertion errors. Therefore, the present embodiment relates to the following design:

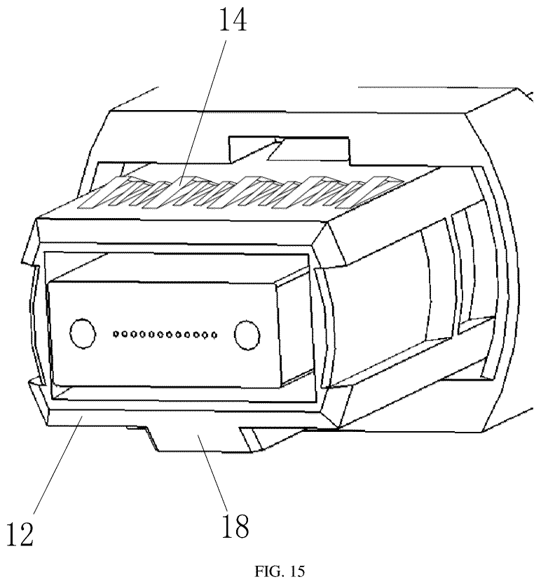

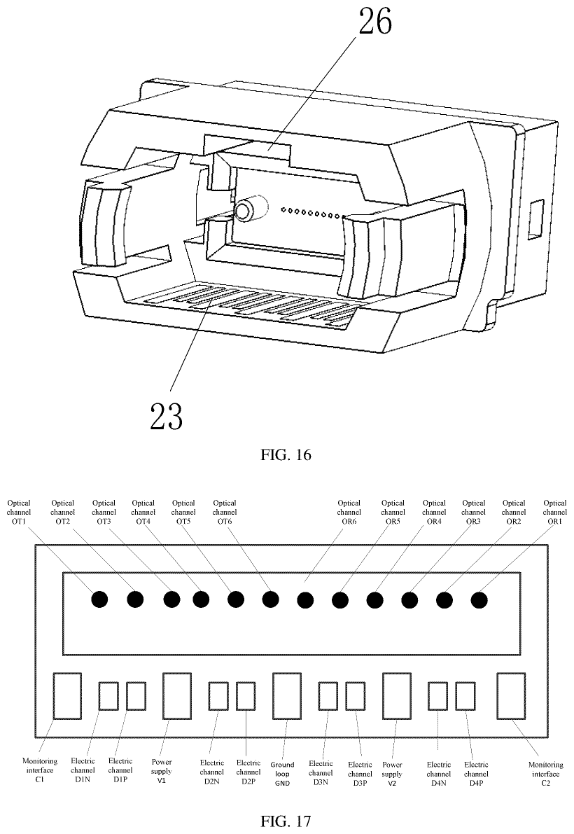

As shown in FIGS. 15 and 16, a convex plate 18 is provided on the inner side end, opposite to the plug-side electric interface 14, of the peripheral joint 12, and a groove 26 is provided on the inner side end, opposite to the socket-side electric interface 23, of the socket slot 21; and when the front end of the photoelectric composite joint 1 is inserted into the socket slot 21 of the photoelectric composite socket 2, the convex plate 18 is inserted into the interior of the groove 26.

Through the above-mentioned convex plate 18 distinguishing one surface of the peripheral joint 12 provided with the plug-side electric interface 14 from one surface without being provided with the plug-side electric interface 14, and due to the fact the corresponding groove 26 is not provided on one side of the socket-side electric channel disposed within the socket slot 21, the convex plate 18 will be blocked by the periphery of the socket slot 21 when the photoelectric composite joint 1 is inserted in reverse, which renders the photoelectric composite joint 1 not be able to enter the socket slot 21, directly avoiding the possibility of reverse insertion of the photoelectric composite joint 1. When a user finds that the photoelectric composite joint 1 cannot be inserted into the photoelectric composite socket 2, he can know that he has just taken the photoelectric composite joint 1 upside down, and at this time, the photoelectric composite joint 1 is flipped by 180 degrees and then is inserted again, thus it can be successfully inserted, so that a user does not need to confirm in advance during insertion, and the experience in actual use is optimized.

It is worth mentioning that the photoelectric composite connector integrated with multiple photoelectric channels provided by the present embodiment can be applied to a scene of parallel transmission of signals and electric energy with different functions and specifications. Under the environment of mixed transmission of signals and energy of various specifications such as an HDMI interface, a DP interface and a USB interface, by adopting the interface and the matching cable equipment of the present embodiment, the limitation of power, control, interference, distance limitation and the like of a pure cable networking can be simply and efficiently broken through, achieving a higher system level. The data line connector and the data line can also be designed to use the photoelectric composite cable 15 and the active photoelectric composite cable head in the present embodiment on cables such as an RJ45 network cable, a USB data line and the like which are forwarded by multichannel-various parallel mixed data, achieving a breakthrough improvement in indicators such as transmission distance, communication rate, application scene and deployment maintenance flexibility.

### Embodiment 2

Based on Embodiment 1, Embodiment 2 of the present disclosure provides a photoelectric composite connector integrated with multiple photoelectric channels, which is displayed in a practical application scene.

The photoelectric composite connector integrated with multiple photoelectric channels provided by the present embodiment is applied to the high-performance data acquisition and transmission equipment with a control capacity, the interface definition of the photoelectric composite connector of the present embodiment is shown in FIG. 17, wherein the optical channel OT1 to the optical channel OT6 are configured to realize the emission of six paths of optical signals, and the optical channel OR1 to the optical channel OR6 is configured to realize the reception of six paths of optical signals. The electric channel DIP and the electric channel DIN, the electric channel D2P and the electric channel D2N, the electric channel D3P and the electric channel D3N, the electric channel D4P and the electric channel D4N are respectively configured to transmit high-speed electric signals, and the monitoring interface C1 and the monitoring interface C2 are configured to provide equipment monitoring lines. The power supply V1 and the power supply V2 together form loop power supply with the ground, and GND is a ground loop.

When the high-performance data acquisition and transmission equipment is started, the ground loop GND keeps a link, and the source-end equipment power supply is powered and started through a power supply V1 interface. Whether the equipment connection condition is normal or not is monitored through the monitoring interface C1, and when the monitoring interface C1 feeds back that the remote equipment is normally started, it means that the remote equipment is in a working-ready state at this moment. The source-end equipment and the remote equipment perform self-test through the electrical signal D1P and the electric channel DIN, the electric channel D2P and the electric channel D2N, the electric channel D3P and the electric channel D3N, the electric channel D4P and the electric channel D4N, and after it is confirmed by the communication that the remote equipment and the source-end equipment system are normal in self-test and satisfy the starting function condition, the source-end equipment starts a power supply to supply power to the remote equipment through the power supply V2, the remote equipment starts the core functional component and monitors and feeds back the working state through the monitoring interface C2. At this time, a large amount of data information is transmitted through the optical channel OT1 to the optical channel OT6 and the optical channel OR1 to the optical channel OR6.

the foregoing embodiments are merely preferred embodiments of the present disclosure, and are not intended to limit the present disclosure, and any modifications, equivalent replacements, improvements, etc. made within the spirit and principles of the present disclosure shall be included within the scope of protection of present disclosure.

1. A photoelectric composite connector integrated with multiple photoelectric channels, comprising a photoelectric composite joint and a photoelectric composite socket, wherein:
a front end of the photoelectric composite joint comprises a center joint and a peripheral joint, and the peripheral joint is arranged around a periphery of the center joint;
at least two plug-side optical interfaces are provided on an end face of the center joint, and at least two plug-side electric interfaces are provided on a side face of the peripheral joint;
a front end of the photoelectric composite socket comprises a socket slot, with at least two socket-side optical interfaces provided on an inner end face of the socket slot, and at least two socket-side electric interfaces provided on an inner side wall of the socket slot;
when the front end of the photoelectric composite joint is inserted into the socket slot of the photoelectric composite socket, the plug-side optical interfaces are connected with the socket-side optical interfaces for transmitting optical signals, and the plug-side electric interfaces are connected with the socket-side electric interfaces for transmitting electric signals.

2. The photoelectric composite connector integrated with multiple photoelectric channels of claim 1, wherein the center joint and the peripheral joint are located at the front end of the photoelectric composite joint, and a rear end of the photoelectric composite joint is a housing, on an end face of which the center joint and the peripheral joint are both provided for inserting into the photoelectric composite socket;
the center joint is in a cuboid shape and provided in a true center of the end face of the housing, while the peripheral joint is in a hollow cylindrical shape and provided around the center joint, and the peripheral joint is a hollow cuboid, which matches with the center joint at the center in shape, with an interval space existing between the center joint and the peripheral joint to distinguish the two joints.

3. The photoelectric composite connector integrated with multiple photoelectric channels of claim 2, wherein the at least two plug-side optical interfaces are configured to transmit optical signals; and
the socket-side electric interface is provided on a lower end side wall of the inner side wall of the socket slot.

4. The photoelectric composite connector integrated with multiple photoelectric channels of claim 3, wherein the plug-side optical interface is arranged in an array on the end face of the center joint.

5. The photoelectric composite connector integrated with multiple photoelectric channels of claim 4, wherein the optical signals transmitted by an optical channel comprise one or more of a digital signal, an analog signal and a high-order modulation signal; and
the electric signals transmitted by an electric channel comprises one or more of a digital signal, an analog signal, a high-order modulation signal, a time division multiplexing signal, a wavelength division multiplexing signal, and a power carrier signal.

6. The photoelectric composite connector integrated with multiple photoelectric channels of claim 1, wherein a rear end of the photoelectric composite joint is connected with a photoelectric composite cable which comprises an optical transmission cable and an electric transmission cable, wherein:
the optical transmission cable is connected with the plug-side optical interface of the center joint; and
the electric transmission cable is connected with the plug-side electric interface of the peripheral joint.

7. The photoelectric composite connector integrated with multiple photoelectric channels of claim 6, wherein each plug-side electric interface comprises an interface slot and a metal elastic sheet, wherein:
the interface slot is provided on a surface of the side face of the peripheral joint, and the metal elastic sheet is connected with the electric transmission cable and extends out of the surface of the peripheral joint through the interface slot;
when the front end of the photoelectric composite joint is inserted into the socket slot of the photoelectric composite socket, the metal elastic sheet is configured to be pressed by the photoelectric composite joint and is connected with the socket-side electric interface.

8. The photoelectric composite connector integrated with multiple photoelectric channels of claim 7, wherein the interface slots are all strip-shaped slots, and lead to an interior of the peripheral joint;
the electric transmission cable enters the interior of the peripheral joint from the housing of the rear end, and one side of the metal elastic sheet is connected with the electric transmission cable within the interface slot, while the other side of the metal elastic sheet extends out of the interface slot;
when the front end of the photoelectric composite joint is inserted into the socket slot of the photoelectric composite socket, and when a part of the metal elastic sheet extending out of the interface slot is subjected to pressure from a socket-side electric channel, the metal elastic sheet is pressed into the interface slot, while an elastic restoring force of the metal elastic sheet enables the metal elastic sheet to abut against the socket-side electric channel, which ensures the metal elastic sheet to be tightly connected with the socket-side electric channel; and
when the front end of the photoelectric composite joint is pulled out from the socket slot, the pressure that the part of the metal elastic sheet extending out of the interface slot is subjected to is removed, and the metal elastic sheet rebounds and protrudes again from the interface slot due to the elastic restoring force.

9. The photoelectric composite connector integrated with multiple photoelectric channels of claim 7, wherein the metal elastic sheet comprises a long side, a short side and a bottom edge, wherein:
the bottom edge is located in the interface slot and is connected with the electric transmission cable;
one end of the long side is elastically connected with the bottom edge, and the other end of the long side extends out of one end of an outer side of the interface slot, and is elastically connected with one end of the short side in a preset angle, while the other end of the short side is immerged into the interface slot;
when the front end of the photoelectric composite joint is inserted into the socket slot of the photoelectric composite socket, the photoelectric composite joint presses the long side, both the long side and the short side being pressed into the interior of the interface slot, and the long side is configured to connect with the socket-side electric interface.

10. The photoelectric composite connector integrated with multiple photoelectric channels of claim 9, wherein the long side, the short side and the bottom edge are all strip-shaped metals, the long side, the short side and the bottom edge being integrally formed, and the bottom edge is located in the interface slot, parallel to the surface of the peripheral joint, and is connected with the long side at an acute angle.

11. The photoelectric composite connector integrated with multiple photoelectric channels of claim 1, wherein a positioning empty slot is provided between the center joint and the peripheral joint; and a positioning convex plate is provided on a periphery of the socket-side optical interface in the socket slot;
when the front end of the photoelectric composite joint is inserted into the socket slot of the photoelectric composite socket, the positioning convex plate is configured to be inserted into the positioning empty slot.

12. The photoelectric composite connector integrated with multiple photoelectric channels of claim 11, wherein a contour of the positioning empty groove is in a shape of a hollow column, and a contour of the positioning convex plate is consistent with that of the positioning empty slot;
when the front end of the photoelectric composite joint is inserted into the socket slot of the photoelectric composite socket, the center joint is inserted into a center of the positioning convex plate to position the center joint.

13. The photoelectric composite connector integrated with multiple photoelectric channels of claim 1, wherein chamfer buckles are provided on both sides of the photoelectric composite socket, and buckle slots are provided on both sides of the peripheral joint;
when the front end of the photoelectric composite joint is inserted into the socket slot of the photoelectric composite socket, the chamfer buckle is located in the buckle slot, and an inner side of the chamfer buckle abuts against an inner side wall of the buckle slot, so as to realize the fixation of the photoelectric composite joint and the photoelectric composite socket.

14. The photoelectric composite connector integrated with multiple photoelectric channels of claim 13, wherein a chamfer at a front end of the chamfer buckle faces an inner side of the socket slot, and an inclined surface of the chamfer faces an insertion direction of the photoelectric composite joint;
when the photoelectric composite joint is inserted into the socket slot, the photoelectric composite joint stretches the chamfer buckle towards two sides along the inclined surface of the chamfer until the chamfer reaches a position where the buckle slot is located, and the chamfer is rebounded into the buckle slot by means of a rebound force of the chamfer buckle itself;
the inner side of the chamfer buckle is a barb portion of the chamfer, after the chamfer rebounds into the buckle slot, the barb portion of the chamfer is stuck on an inner wall of the buckle slot, preventing the photoelectric composite joint from disengaging from the photoelectric composite socket.

15. The photoelectric composite connector integrated with multiple photoelectric channels of claim 1, wherein when the front end of the photoelectric composite joint is inserted into the socket slot of the photoelectric composite socket, the socket-side electric interface is connected with the plug-side electric interface as an electric channel, and the electric channel comprises an electric energy channel and an electric signal channel;
wherein a first preset quantity of the socket-side electric interfaces are connected with the first preset quantity of the plug-side electric interfaces as the electric signal channels, and a second preset quantity of the socket-side electric interfaces are connected with the second preset quantity of the plug-side electric interface as the electric energy channels

16. The photoelectric composite connector integrated with multiple photoelectric channels of claim 15, wherein every two or more electric signal channels are adjacently arranged as one group, and at least one electric energy channel is arranged between each group of electric signal channels for separating different groups of electric signal channels.

17. The photoelectric composite connector integrated with multiple photoelectric channels of claim 1, wherein a convex plate is provided on an inner side end, opposite to the plug-side electric interface, of the peripheral joint, and a groove is provided in an inner side end, opposite to the socket-side electric interface, of the socket slot;
when the front end of the photoelectric composite joint is inserted into the socket slot of the photoelectric composite socket, the convex plate is inserted into the groove.

18. The photoelectric composite connector integrated with multiple photoelectric channels of claim 1, wherein the optical signals comprise one or more of a digital signal, an analog signal and a high-order modulation signal; and the electric signal comprises one or more of a digital signal, an analog signal, a high-order modulation signal, a time division multiplexing signal, a wavelength division multiplexing signal, and a power carrier signal.
